(19) United States
(12) Patent Application Publication
(10) Pub. No.: US 2010/0018197 A1
(43) Pub. Date: Jan. 28, 2010

(54) PIPE LAYER HAVING SWING SPEED ADJUSTABLE SYSTEM

(75) Inventors: Myeong Seok YOO, Changwon (KR); Soo Bong Hwang, Gimhae-si (KR)

Correspondence Address: LADAS & PARRY LLP, 26 WEST 61ST STREET, NEW YORK, NY, 10023, US

(73) Assignee: VOLVO CONSTRUCTION EQUIPMENT HOLDING SWEDEN AB

(21) Appl. No.: 12/507,867

(22) Filed: Jul. 23, 2009

(30) Foreign Application Priority Data
Jul. 26, 2008 (KR) 10-2008-0073282

(51) Int. Cl. F15B 11/17

(52) U.S. Cl. 60/420

(57) ABSTRACT

A pipe layer having a swing speed adjustable system is provided, which can be used as a pipe layer or an excavator through replacement of attachments in accordance with work conditions, so that it serves as the pipe layer when it is required to pull up and carry a heavyweight oil pipe in order to lay the oil pipe under the ground, while it serves as the excavator when a quick swing work is required. The pipe layer having a swing speed adjustable system includes first and second variable displacement hydraulic pumps connected to an engine, control valves installed in a center bypass path of the first hydraulic pump, control valves installed in a center bypass path of the second hydraulic pump, a straight traveling valve installed on an upstream side of the center bypass passage of the first hydraulic pump to supply the hydraulic fluid from the first and second hydraulic pumps to a boom cylinder, a swing motor, a winch motor, and left and right traveling motors, respectively, and a variable load-hold check valve installed in an inlet-side flow path of the swing motor control valve to variably adjust a stroke of a poppet so that the amount of hydraulic fluid being supplied to the swing motor can be variably adjusted.

### CROSS-REFERENCE TO RELATED APPLICATION

This application is based on and claims priority from Korean Patent Application No. 10-2008-0073282, filed on Jul. 26, 2008 in the Korean Intellectual Property Office, the disclosure of which is incorporated herein in its entirety by reference.

### BACKGROUND OF THE INVENTION

1. Field of the Invention

The present invention relates to a pipe layer having a swing speed adjustable system, which can be used as a pipe layer or an excavator through replacement of attachments in accordance with work conditions, so that it serves as the pipe layer when it is required to pull up and carry a heavyweight oil pipe in order to lay the oil pipe under the ground, while it serves as the excavator when a quick swing work is required.

More particularly, the present invention relates to a pipe layer having a swing speed adjustable system, which can adjust the required flow rate being applied to a swing motor in the case of swing an excavator or a pipe layer, and thus can optionally control the maximum swing speed of the excavator or the pipe layer through replacement of attachments (e.g. a boom, a bucket, and the like) in accordance with work conditions.

2. Description of the Prior Art

Generally, in the case of laying heavyweight oil pipes, water pipes, and the like, under the ground, a movable exclusive crane is used to carry the pipes to a place where the pipes are to be laid under the ground.

However, if shaking of the oil pipe occurs due to the uneven ground or the operator's unskilled manipulation of the equipment while the crane is moved in a state where the oil pipe is pulled up using a flexible wire rope wound on a winch of the crane, collision may occur between the oil pipe and a part of the equipment to damage the equipment and the oil pipe. Also, if the center of gravity is lost due to the shaking of the oil pipe and so on, the oil pipe may secede from the rope to cause the injury of the operator and the damage of goods surrounding the work place.

Accordingly, a pipe layer, in which an upper frame is mounted to swivel on a lower driving structure so that the inherent works (e.g. traveling, swing, and the like) of the excavator can be done, has been developed and used. This pipe layer can pull up and carry the oil pipe using a hook which is fixed to an end part of an attachment (e.g. a boom, a bucket, or the like) that is replaced in accordance with work conditions, and is lifted by a wire rope.

As illustrated in FIG. 1, a conventional pipe layer having a swing speed adjustable system includes first and second variable displacement hydraulic pumps 2 and 3 connected to an engine 1; a left traveling motor 4 and a boom cylinder 5 connected to the first hydraulic pump 2; control valves 7 and 8 installed in a center bypass path 6 of the first hydraulic pump 2, and shifted to control the flow direction and flow amount of hydraulic fluid being supplied to the left traveling motor 4 and the boom cylinder 5; a right traveling motor 9, a swing motor 10, and a winch motor 11 connected to the second hydraulic pump 3; control valves 13, 14, and 15 installed in a center bypass path 12 of the second hydraulic pump 3, and shifted to control the flow direction and flow amount of hydraulic fluid being supplied to the right traveling motor 9, the swing motor 10, and the winch motor 11; and a straight traveling valve 16 installed on an upstream side of the center bypass passage 6 of the first hydraulic pump 29 to prevent declination of construction equipment, and shifted, in response to a signal pressure applied from an outside in the case of simultaneously manipulating a working device and a traveling device, to supply the hydraulic fluid fed from the first hydraulic pump 2 to the boom cylinder 5, the swing motor 10, and the winch motor 11, and to distribute and supply the hydraulic fluid fed from the second hydraulic pump 3 to the left and right traveling motors 4 and 9.

In the drawing, a reference numeral 17 denotes a remote control valve (RCV) outputting a signal pressure in proportion to a manipulation amount thereof to drive a working device, a reference numeral 18 denotes a traveling pedal outputting a signal pressure in proportion to a manipulation force thereof to drive a traveling device, and a reference numeral 40 denotes a main relief valve to drain a part of the hydraulic fluid to a hydraulic tank when overload that exceeds the pressure set in a hydraulic circuit is generated.

As illustrated in FIGS. 1 and 2, a conventional swing speed adjustable system for swing the pipe layer includes a fixed load-hold check valve 22 (i.e. a fixed orifice 20 and a backward flow prevention check valve 21) installed in an inlet-side flow path 19 of a swing motor control valve 14 to prevent the increase of the swing speed of a swing motor 10.

The fixed load-hold check valve 22 includes a valve seat 25 in which the inlet-side flow path 19 is formed; a poppet 24 installed to open/close the inlet-side flow path 19; an adjustment block 26 engaged with the valve seat 25 to press the poppet 24 so that the inlet-side flow path 19 is opened only in the case where the pressure in the flow path 19 exceeds a preset pressure; and an elastic member (e.g. compression coil spring) 27 installed between the poppet 24 and the adjustment block 26 to press the poppet 24 so that the poppet is elastically biased in its initial state to block the inlet-side flow path 19.

According to the conventional swing speed adjustable system, the amount of hydraulic fluid, which corresponds to a fully open area of the fixed orifice 20, is supplied to the swing motor 10. Accordingly, if the swing speed of the swing motor 10 is increased in a state where a heavyweight oil pipe is pulled by a flexible wire rope supported on a hook of a pipe layer, the oil pipe may secede from the wire rope and fall down due to shaking of the oil pipe, or may collide with a part of the equipment neighboring the oil pipe.

That is, in the case of swinging an upper frame of the equipment in a state where the oil pipe is pulled using the wire rope supported on the hook of the pipe layer, it is required to reduce the swing speed of the pipe layer relatively to the swing speed of the excavator.

On the other hand, in the case of swinging the upper frame in the excavator, a quick swing speed is required in consideration of the work efficiency. That is, in the case where the amount of hydraulic fluid, which corresponds to the fully open area of the orifice, is supplied to the swing motor to swing the upper frame quickly in a state where a load is applied to a bucket, a safety accident such as in the pipe layer may occur due to the structural characteristic of working devices, such as a boom, an arm, and the like, composed of rigid members.

### SUMMARY OF THE INVENTION

Accordingly, the present invention has been made to solve the above-mentioned problems occurring in the prior art while advantages achieved by the prior art are maintained intact.

Embodiments of the present invention relate to a pipe layer having a swing speed adjustable system, which can variably adjust the amount of hydraulic fluid being supplied to a swing motor, and thus can optionally control the maximum swing speed in accordance with the use purpose of an excavator or a pipe layer, that can be effected through replacement of attachments in accordance with work conditions.

Embodiments of the present invention relate to a pipe layer having a swing speed adjustable system, which can heighten the swing speed to improve the work efficiency when it is used as an excavator, and which can reduce the maximum swing speed to secure the safety when it is used as a pipe layer having inherent functions (e.g. traveling, swing, and the like) of the excavator.

In one aspect of the present invention, there is provided a pipe layer having a swing speed adjustable system, which includes first and second variable displacement hydraulic pumps connected to an engine; a left traveling motor and a boom cylinder connected to the first hydraulic pump; control valves installed in a center bypass path of the first hydraulic pump, and shifted to control the flow direction and flow amount of hydraulic fluid being supplied to the left traveling motor and the boom cylinder; a right traveling motor, a swing motor, and a winch motor connected to the second hydraulic pump; control valves installed in a center bypass path of the second hydraulic pump, and shifted to control the flow direction and flow amount of hydraulic fluid being supplied to the right traveling motor, the swing motor, and the winch motor; a straight traveling valve installed on an upstream side of the center bypass passage of the first hydraulic pump, and shifted, in response to a signal pressure applied from an outside in a work mode for simultaneously driving a working device and a traveling device, to supply the hydraulic fluid fed from the first hydraulic pump to the boom cylinder, the swing motor, and the winch motor, and to supply the hydraulic fluid fed from the second hydraulic pump to the left and right traveling motors, respectively; and a variable load-hold check valve installed in an inlet-side flow path of the swing motor control valve to variably adjust a stroke of a poppet so that the amount of hydraulic fluid being supplied to the swing motor can be variably adjusted.

The variable load-hold check valve may include a valve seat in which the inlet-side flow path is formed; a backward flow prevention poppet installed to open/close the inlet-side flow path; an adjustment block engaged with the valve seat to press the poppet so that the inlet-side flow path is opened only in the case where the pressure in the flow path exceeds a preset pressure; an elastic member installed between the poppet and the adjustment block to press the poppet so that the poppet is elastically biased in its initial state to block the inlet-side flow path; and an adjuster screw-engaged with the adjustment block to variably adjust the stroke of the poppet in accordance with its rotation direction.

With the above-described construction, the pipe layer having a swing speed adjustable system according to embodiments of the present invention has the following advantages.

The pipe layer can variably adjust the amount of hydraulic fluid being supplied to a swing motor, and thus can optionally control the maximum swing speed in accordance with the use purpose of an excavator or a pipe layer, which can be effected through replacement of attachments in accordance with work conditions.

Also, the pipe layer can improve the work efficiency due to the quick swing speed of an upper frame when it is used as an excavator, and can minimize shaking of an oil pipe, which is pulled and carried by a wire rope, through reduction of the maximum swing speed to secure the safety when it is used as a pipe layer.

### BRIEF DESCRIPTION OF THE DRAWINGS

The above and other objects, features and advantages of the present invention will be more apparent from the following detailed description taken in conjunction with the accompanying drawings, in which:

FIG. 1 is a hydraulic circuit diagram of a conventional pipe layer having a swing speed adjustable system;

FIG. 2 is a section view of a main part of a swing device for swinging an upper frame of a conventional pipe layer;

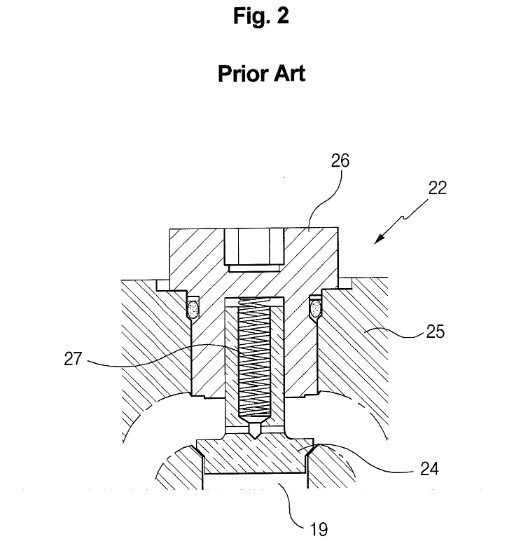

FIG. 3 is a hydraulic circuit diagram of a pipe layer having a swing speed adjustable system according to an embodiment of the present invention;

FIG. 4 is a sectional view of a main part of a swing device according to an embodiment of the present invention; and

FIG. 5 is a perspective view of a pipe layer on which a swing speed adjustable system is mounted according to an embodiment of the present invention.

### DETAILED DESCRIPTION OF THE PREFERRED EMBODIMENTS

Hereinafter, preferred embodiments of the present invention will be described with reference to the accompanying drawings. The matters defined in the description, such as the detailed construction and elements, are nothing but specific details provided to assist those of ordinary skill in the art in a comprehensive understanding of the invention, and thus the present invention is not limited thereto.

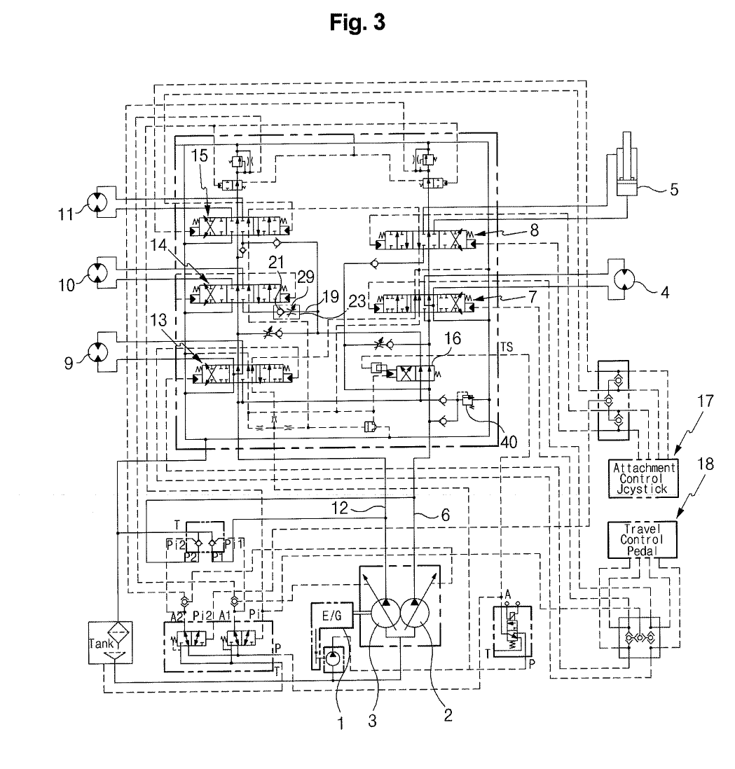

As illustrated in FIGS. 3 to 5, a pipe layer having a swing speed adjustable system according to an embodiment of the present invention includes first and second variable displacement hydraulic pumps 2 and 3 connected to an engine 1; a left traveling motor 4 and a boom cylinder 5 connected to the first hydraulic pump 2; control valves 7 and 8 installed in a center bypass path 6 of the first hydraulic pump 2, and shifted to control the flow direction and flow amount of hydraulic fluid being supplied to the left traveling motor 4 and the boom cylinder 5; a right traveling motor 9, a swing motor 10, and a winch motor 11 connected to the second hydraulic pump 3; control valves 13, 14, and 15 installed in a center bypass path 12 of the second hydraulic pump 3, and shifted to control the flow direction and flow amount of hydraulic fluid being supplied to the right traveling motor 9, the swing motor 10, and the winch motor 11; a straight traveling valve 16 installed on an upstream side of the center bypass passage 6 of the first hydraulic pump 2, and shifted, in response to a signal pressure applied from an outside in a work mode for simultaneously driving a working device and a traveling device, to supply the hydraulic fluid fed from the first hydraulic pump 2 to the boom cylinder 5, the swing motor 10, and the winch motor 11, and to supply the hydraulic fluid fed from the second hydraulic pump 3 to the left and right traveling motors 4 and 9, respectively; and a variable load-hold check valve 23 (i.e. a backward flow prevention check valve 21 and a variable orifice 29) installed in an inlet-side flow path 19 of the swing motor control valve 14 to variably adjust a stroke of a poppet 24 so that the amount of hydraulic fluid being supplied to the swing motor 10 can be variably adjusted.

The variable load-hold check valve 23 may include a valve seat 25 in which the inlet-side flow path 19 is formed; a backward flow prevention poppet 24 installed to open/close the inlet-side flow path 19; an adjustment block 26 screw-engaged with the valve seat 25 to press the poppet 24 so that the inlet-side flow path 19 is opened only in the case where the pressure in the flow path 19 exceeds a preset pressure; an elastic member (e.g. a compression coil spring) 27 installed between the poppet 24 and the adjustment block 26 to press the poppet 24 so that the poppet 24 is elastically biased in its initial state to block the inlet-side flow path 19; and an adjuster (e.g. a screw) 28 screw-engaged with the adjustment block 26 to variably adjust the stroke of the poppet 24 in accordance with its rotation direction.

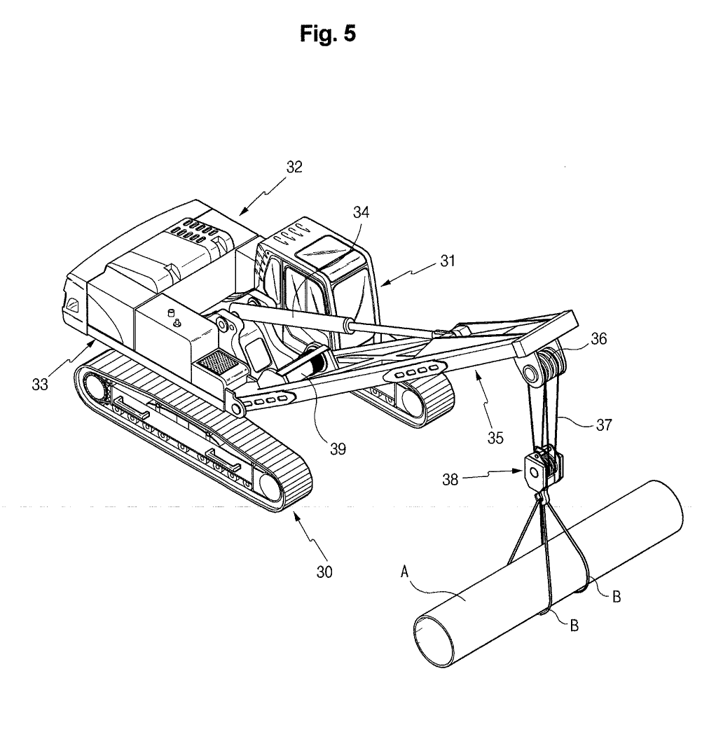

As illustrated in FIG. 5, a pipe layer on which a swing speed adjustable system is mounted according to an embodiment of the present invention includes a lower driving structure 30; an upper frame 33 mounted to swivel on the lower driving structure 30, and provided with a cab 31 and an engine room 32 mounted thereon; a boom 35 having a lower end part rotatably fixed to the upper frame 33, and rotated by the driving of a boom cylinder 34; a hook 38 ascending/descending by a wire rope 37 that is supported on a sheave 36 fixed to an upper part of the boom 35; and a winch 39 on which the wire rope 37 is wound.

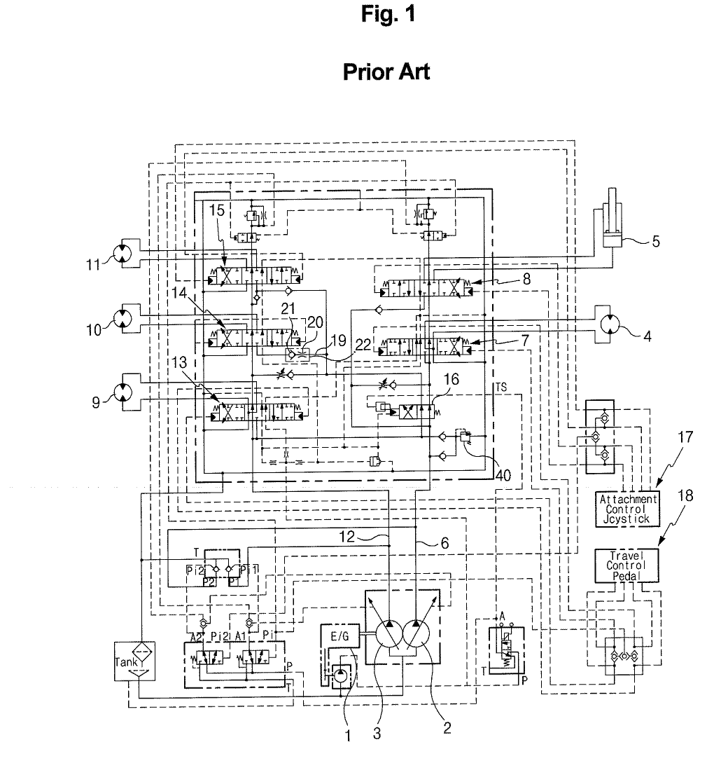

Since the construction, except for the variable load-hold check valve 23 installed in the inlet-side flow path 19 of the swing motor control valve 14 to variably adjust the stroke of the poppet 24 so that the amount of hydraulic fluid being supplied to the swing motor 10 can be variably adjusted, is substantially the same as that as illustrated in FIG. 1, the detailed description of the construction and operation thereof will be omitted. In the following description of the present invention, the same drawing reference numerals are used for the same elements across various figures.

Hereinafter, the operation of the pipe layer having a swing speed adjustable system according to an embodiment of the present invention will be described in detail with reference to the accompanying drawings.

The pipe layer according to the present invention can be used as an excavator (in this case, attachments, such as a boom, an arm, and a bucket, are mounted thereon) or as the pipe layer (in this case, attachments, such as a boom, a hook, and a winch, are mounted thereon) in accordance with the work conditions. In this case, the maximum swing speed of the swing motor 10 can be adjusted by variably adjusting the amount of hydraulic fluid being supplied to the swing motor 10.

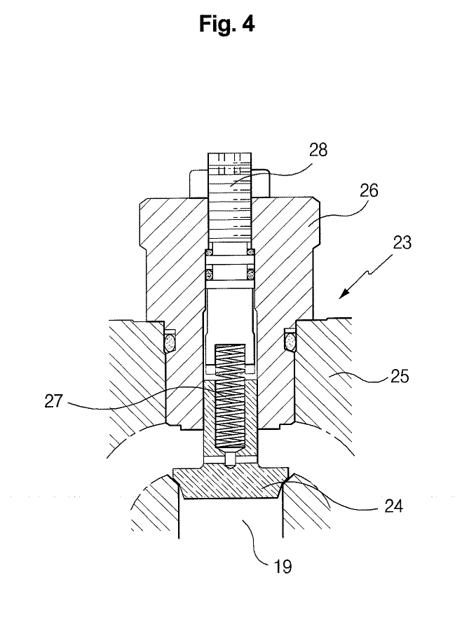

As illustrated in FIG. 4, in the case of rotating the screw type adjuster 28 screw-engaged with the adjustment block 26 clockwise as shown in the drawing, it moves downward for a specified distance (indicated by a virtual line in the drawing), and thus the compression force of the elastic member 27 that presses the poppet 24 is increased. Accordingly, the stroke of the poppet 24 of the variable load-hold check valve 23 installed in the inlet-side flow path 19 of the swing control valve 14 is reduced, and thus the fully open area of the variable orifice 29 is reduced.

Accordingly, as illustrated in FIG. 5, in the case of using the equipment as a pipe layer for pulling up a heavyweight oil pipe A using a wire rope B fixed to the hook 38 and carrying the oil pipe A to a specified place (in which an excavated groove is formed to lay the oil pipe under the ground), the fully open area of the variable orifice 29 is reduced to reduce the amount of hydraulic fluid being supplied to the swing motor 10, and thus the maximum swing speed of the swing motor 10 can be reduced.

Accordingly, if the upper frame 33 is swiveled by the driving of the swing motor 10 in a state where the heavyweight oil pipe A is pulled up by the flexible wire rope B supported on the hook 38 of the pipe layer, it can be minimized that the oil pipe A secedes from the wire rope B due to the shaking.

On the other hand, although not illustrated in the drawing, in order to use the equipment as an excavator through replacement of the corresponding attachments (a boom, an arm, a bucket, a hydraulic cylinder, and the like), the fully open area of the variable orifice 29 is adjusted to increase the amount of hydraulic fluid being supplied to the swing motor 10.

That is, in the case of rotating the screw-type adjuster 28 screw-engaged with the adjustment block 26 of the variable load-hold check valve 23 counterclockwise as shown in the drawing, it moves upward for a specified distance, and thus the compression force of the elastic member 27 that presses the poppet 24 is reduced.

In this case, the stroke of the poppet 24 installed in the inlet-side flow path 19 of the swing control valve 14 is extended, and thus the fully open area of the variable orifice 29 is increased.

Accordingly, in the case of swinging the upper frame in a state where a load is applied to the bucket of the excavator, the fully open area of the variable orifice 29 is extended to increase the supply amount of hydraulic fluid to the swing motor 10. Accordingly, the maximum swing speed of the swing motor 10 is relatively increased in comparison to the swing speed of the pipe layer, and thus the work efficiency is improved.

As described above, the pipe layer having a swing speed adjustable system according to the embodiment of the present invention can serve as an excavator or a pipe layer through replacement of attachments in accordance with work conditions. In the case of using the equipment as an excavator, a quick swing speed is secured by increasing the amount of hydraulic fluid being supplied to the swing motor, and thus the work efficiency can be heightened.

By contrast, in the case of using the equipment as a pipe layer, the shaking of oil tanks is minimized by reducing the maximum swing speed of the swing motor, and thus the safety can be secured.

Although preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A pipe layer having a swing speed adjustable system, comprising:
first and second variable displacement hydraulic pumps connected to an engine;
a left traveling motor and a boom cylinder connected to the first hydraulic pump;
control valves installed in a center bypass path of the first hydraulic pump, and shifted to control the flow direction and flow amount of hydraulic fluid being supplied to the left traveling motor and the boom cylinder;
a right traveling motor, a swing motor, and a winch motor connected to the second hydraulic pump;
control valves installed in a center bypass path of the second hydraulic pump, and shifted to control the flow direction and flow amount of hydraulic fluid being supplied to the right traveling motor, the swing motor, and the winch motor;
a straight traveling valve installed on an upstream side of the center bypass passage of the first hydraulic pump, and shifted, in response to a signal pressure applied from an outside in a work mode for simultaneously driving a working device and a traveling device, to supply the hydraulic fluid fed from the first hydraulic pump to the boom cylinder, the swing motor, and the winch motor, and to supply the hydraulic fluid fed from the second hydraulic pump to the control valves for the left and right traveling motors, respectively; and
a variable load-hold check valve installed in an inlet-side flow path of the swing motor control valve to variably adjust a stroke of a poppet so that the amount of hydraulic fluid being supplied to the swing motor can be variably adjusted.

2. The pipe layer of claim 1, wherein the variable load-hold check valve comprises:
a valve seat in which the inlet-side flow path is formed;
a backward flow prevention poppet installed to open/close the inlet-side flow path;
an adjustment block engaged with the valve seat to press the poppet so that the inlet-side flow path is opened only in the case where the pressure in the flow path exceeds a preset pressure;
an elastic member installed between the poppet and the adjustment block to press the poppet so that the poppet is elastically biased in its initial state to block the inlet-side flow path; and
an adjuster screw-engaged with the adjustment block to variably adjust the stroke of the poppet in accordance with its rotation direction.
